(19) United States
(12) Patent Application Publication
(10) Pub. No.: US 2014/0224853 A1
(43) Pub. Date: Aug. 14, 2014

(54) WINCH CRADLE AND LOCK MECHANISM

(71) Applicant: INTERNATIONAL TRUCK INTELLECTUAL PROPERTY COMPANY, Lisle, IL (US)

(72) Inventors: William Griese, Livonia, MI (US); Brian Enck, Sterling Heights, MI (US)

(73) Assignee: International Truck Intellectual Property Company, Lisle, IL (US)

(21) Appl. No.: 13/766,309

(22) Filed: Feb. 13, 2013

(51) Int. Cl. B60R 11/00

(52) U.S. Cl. CPC B60R 11/00
USPC 224/544; 224/547

(57) ABSTRACT

A cradle winch assembly for easy attachment to and detachment from a vehicle frame is disclosed. The cradle assembly includes a winch cradle for mounting a winch thereon, two drawbars fixed to the winch cradle and extending a distance from the cradle, two receiver brackets configured to be affixed to the vehicle frame and to allow insertion therein of the two drawbars, and a locking mechanism connected to the winch cradle. The disclosed locking mechanism includes a lever, two opposing load-bearing pins, and linkage connecting the lever to the pins wherein the locking mechanism is configured to move between a locked and unlocked position with the pins moving in a direction transverse to the insertion direction of the drawbar into the receiver bracket. The locking mechanism locks the cradle to the vehicle frame when actuated to a locked position by the lever.

### TECHNICAL FIELD

The present device and assembly relate to securing a winch to a vehicle. More specifically, the device and assembly relate to facilitating the securing and detachment of a winch to a vehicle.

### BACKGROUND

The use of a winch has been documented going back to the times of Aristotle, who regarded them as common for architectural use. Employing them on vehicles goes back at least as early as World War II where large military vehicles were equipped with winches for use in everything from construction to demolition, from vehicle towing to general safety. The vehicle mounted winch was primarily permanently affixed directly to the vehicle frame or to a front bumper, which was in-turn coupled to the vehicle frame.

Soon detachable vehicle winches became useful, particularly in the military where the interchangeability of parts between vehicles is extremely useful. However, the current mechanism for mounting and attachment of a removable winch cradle from a vehicle may be cumbersome. Current portable assemblies utilize drawbars similar to trailer hitch drawbars and typically require additional loose pins and locks to be installed. The pins and locks are located on the underside of the drawbar receiving bracket which requires a person to climb under the vehicle for securing or unlocking the assembly. This is an undesirable scenario for many military situations.

To solve these and other problems associated with portable winch cradle assemblies, the disclosed device and system provides a winch cradle assembly with a readily accessible locking mechanism. Further, the disclosed device and system provides greater stability and reliability over prior winch cradle assemblies.

### SUMMARY

A cradle winch assembly for attachment to a vehicle frame is disclosed.

In an embodiment, the cradle assembly comprises a winch cradle for mounting a winch thereon, at least one drawbar fixed to the winch cradle, at least one receiver bracket for affixing to the vehicle frame and configures to allow insertion therein of the at least one drawbar, a locking mechanism connected to the winch cradle and having a lever to actuate the locking mechanism between a locked and an unlocked position in a direction transverse to the insertion direction of the drawbar into the receiver bracket, and wherein the locking mechanism enters the at least one towing hole on the vehicle frame when actuated to a locked position by the lever.

In another embodiment, the cradle assembly comprises a winch cradle for mounting a winch thereon, two drawbars fixed to the winch cradle and extending a distance from the cradle, two receiver brackets configured to be affixed to the vehicle frame and to allow insertion therein of the two drawbars, and a locking mechanism connected to the winch cradle. The disclosed locking mechanism comprises a lever, two opposing load-bearing pins, and linkage connecting the lever to the pins wherein the locking mechanism is configured to move between a locked and unlocked position with the pins moving in a direction transverse to the insertion direction of the drawbar into the receiver bracket. The locking mechanism locks the cradle to the vehicle frame when actuated to a locked position by the lever.

Additional embodiments and features of the assembly can be understood from the appended drawings and the detailed description below.

### BRIEF DESCRIPTION OF THE DRAWINGS

FIG. 1 is a front perspective view of an embodiment of the winch cradle assembly including a winch positioned thereon;

FIG. 2 is a front perspective view of an embodiment of the winch cradle assembly;

FIG. 3 is a rear perspective view of the winch cradle assembly shown in FIG. 2;

FIG. 4 is a side elevation view of an embodiment of the winch cradle assembly attached to a vehicle frame;

FIG. 5 is a rear perspective view of the winch cradle assembly of FIG. 2 attached to a vehicle frame;

FIG. 6 is a perspective view of the lever actuator of the winch cradle assembly in an unlocked position; and

FIG. 7 is a perspective view of the lever actuator of the winch cradle assembly in a locked position.

### DETAILED DESCRIPTION

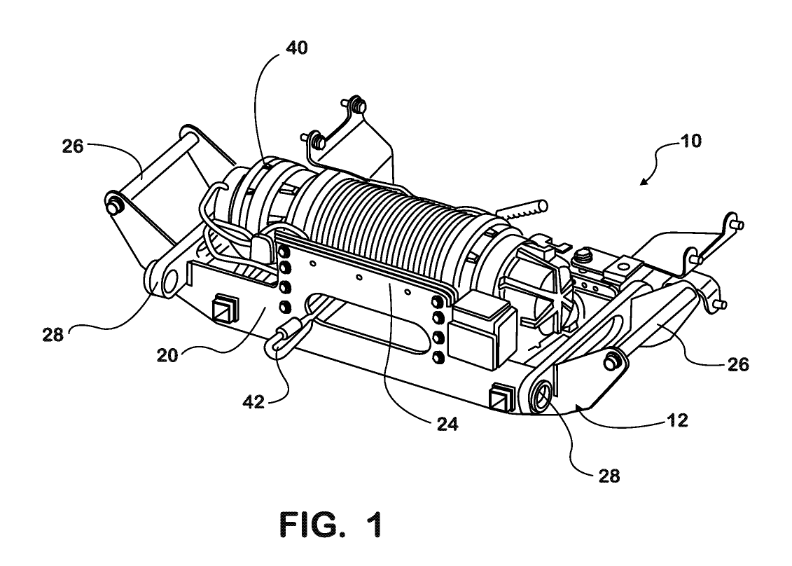

With reference to FIGS. 1-7, an embodiment of the winch cradle assembly can be seen and more readily understood. The assembly is generally indicated in the appended drawings by the numeral 10, and assembly components are consistently identified throughout the drawing figures.

FIG. 1 illustrates an embodiment of assembly 10 comprising a winch cradle 12 into which a winch 40 is mounted and bolted. The cradle 12 is comprised of a high-strength steel frame 20 including winch brackets 22 for supporting a winch thereon, a face plate 24 through which a winch cable 42 may be drawn, side arms 26 for lifting/supporting the cradle 12 during vehicle attachment and detachment, and tow bars 28 for additional cable connections, when needed.

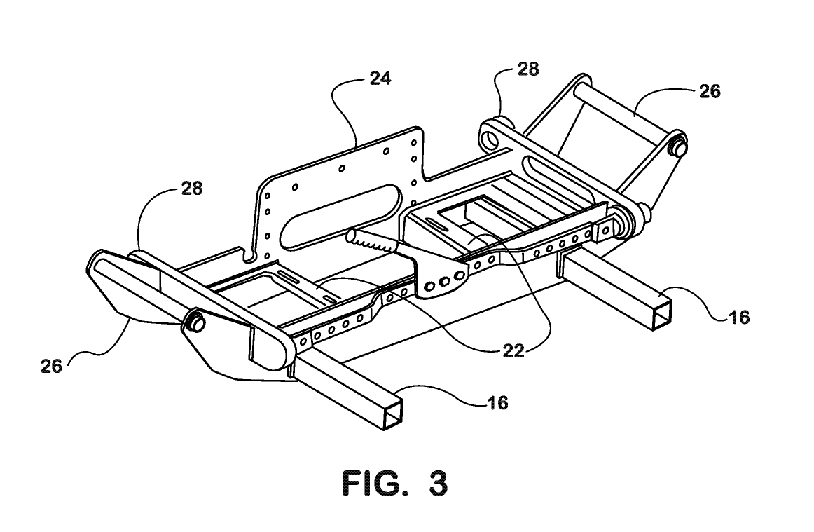

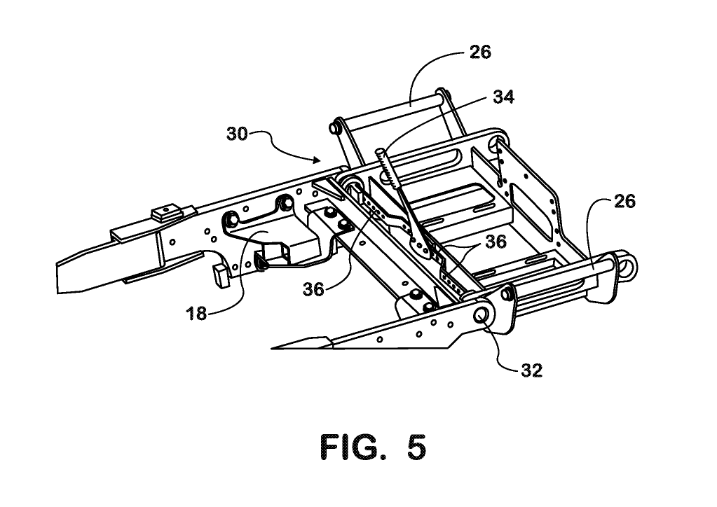

Further, the assembly 10 comprises two square metal tubes 14 running substantially perpendicular to the winch 40 and extending from beneath the cradle 12 to provide the drawbars 16 (FIG. 3) by which the assembly 10 is attached to a vehicle frame. Two receiver brackets 18 provide the corresponding receptacle for the drawbars 16, as they are configured to be bolted directly to a vehicle frame (see FIG. 5).

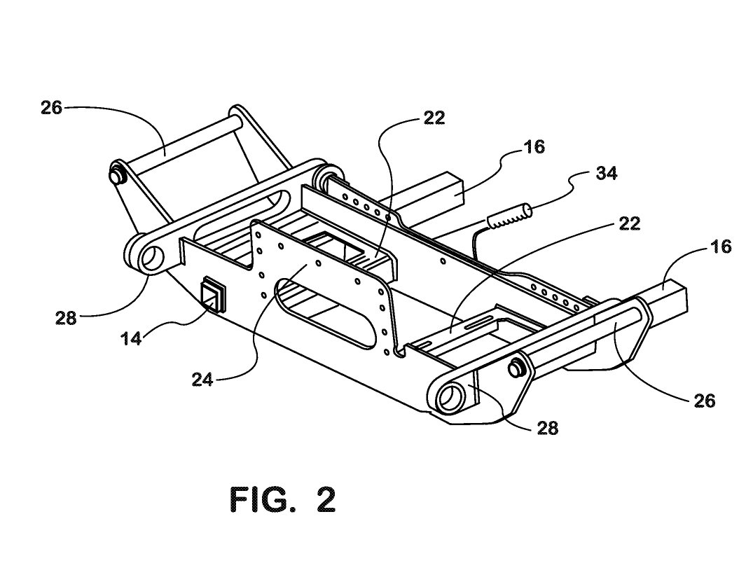

Finally, with reference to FIGS. 2 and 3, the assembly 10 also comprises a locking mechanism 30 which anchors the assembly 10 to the vehicle frame during forward directed forces. The locking mechanism 30 is comprised of two load-bearing pins 32, a lever 34 and linkage 36 connecting the lever 34 to each of the pins 32. The lever 34 is secured to the frame 20 of the cradle 12 to allow pivoting, and on either side of the pivot point a cam-shaped base 35 actuates both halves of linkage 36 to move the two pins 32 between a locked position—i.e., pins 32 extended—and an unlocked position—i.e., pins 32 retracted.

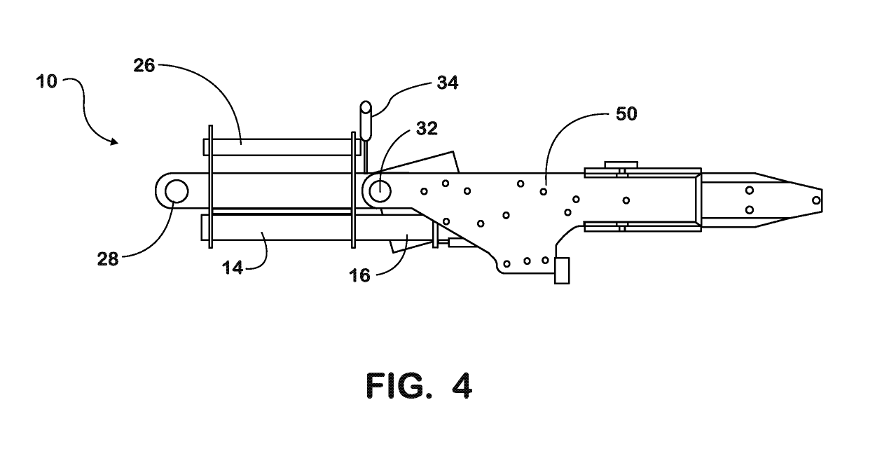

FIGS. 4 and 5 show how the pins 32 align with the existing vehicle frame towing holes once the cradle 12 is secured within the receiver brackets 18. The receiver brackets 18 (FIG. 5) are shown to be mounted to the frame extension 50 just behind the towing holes. Unlike prior winch cradle mounts using a drawbar, the present system does not require additional locking pins to retain the drawbars 16 within the receiver brackets 18.

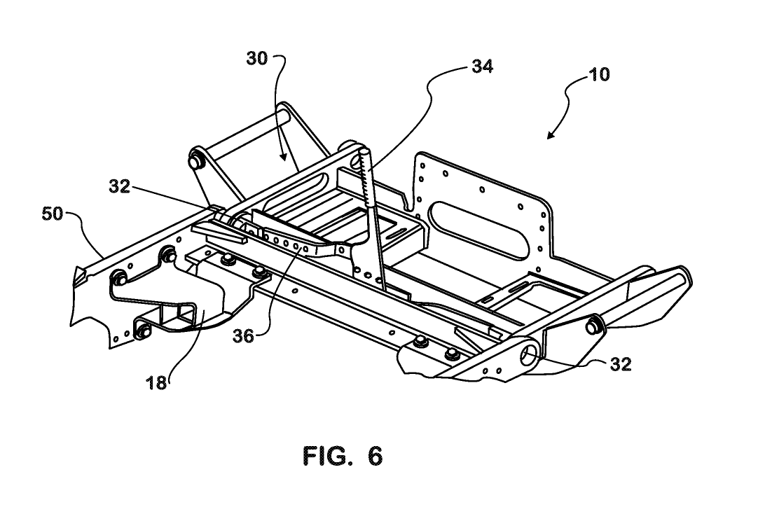

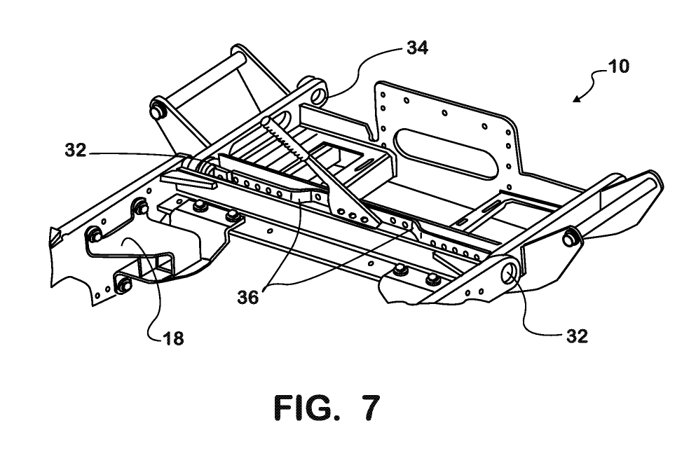

Referring now to FIGS. 6 and 7, operation of the lever 34 and locking mechanism 30 can be more readily understood. The lever 34 begins in an upright, unlocked position as the winch cradle assembly 10 is attached to the vehicle frame. That is, as shown in FIG. 6, the locking mechanism 30 is in an unlocked, pins 32 retracted condition as the drawbars 16 are inserted into the receiver brackets 18 securely bolted to the vehicle frame. Once the winch assembly 10 is seated correctly, the lever 34 can then be moved to the locked position, as shown in FIG. 7. The lever 34 can be readily accessed from the front of the vehicle without having to reach or crawl beneath the cradle assembly 10 or the vehicle, as with prior art systems.

In the locked position, the pins 32 are moved outward into the existing vehicle frame towing holes and the configuration resists parallel forces (i.e., directly forward) exerted on the winch cradle 12. Similarly, the drawbars 16 positioned within the receiver brackets 18 resist angular (0°<φ<90°), vertical and lateral forces even if the lever 34 were in an unlocked condition.

What is claimed is:

1. A detachable winch cradle assembly for attachment to a vehicle frame having at least one towing hole therein, the cradle assembly comprising:
a winch cradle for mounting a winch thereon;
at least one drawbar fixed to the winch cradle;
at least one receiver bracket for affixing to the vehicle frame and configured to allow insertion therein of the at least one drawbar;
a locking mechanism connected to the winch cradle and having a lever to actuate the locking mechanism between a locked and unlocked position in a direction transverse to the insertion direction of the drawbar into the receiver bracket; and
wherein the locking mechanism enters the at least one towing hole on the vehicle frame when actuated to a locked position by the lever.

2. The detachable winch cradle assembly of claim 1, wherein there are two receiver brackets and two drawbars.

3. The detachable winch cradle assembly of claim 1, wherein the locking mechanism comprises at least one load supporting pin which is responsive to actuation by the lever.

4. The detachable winch cradle assembly of claim 1, wherein the at least one receiver bracket is bolted to the vehicle frame.

5. The detachable winch cradle assembly of claim 3, wherein the lever is connected to the locking mechanism via linkage.

6. The detachable winch cradle assembly of claim 1, wherein the lever of the locking mechanism is operable from a position adjacent the winch.

7. The detachable winch cradle assembly of claim 6, wherein the lever comprises a handle and a cam-shaped base attached to linkage connecting to locking pins.

8. A winch cradle assembly for attachment to a vehicle frame, the cradle assembly comprising:
a winch cradle for mounting a winch thereon;
two drawbars fixed to the winch cradle and extending a distance from the cradle;
two receiver brackets configured to be affixed to the vehicle frame and to allow insertion therein of the two drawbars;
a locking mechanism connected to the winch cradle, the locking mechanism comprising a lever, two opposing load-bearing pins, and linkage connecting the lever to the pins wherein the locking mechanism is configured to move between a locked and unlocked position with the pins moving in a direction transverse to the insertion direction of the drawbar into the receiver bracket; and
wherein the locking mechanism locks the cradle to the vehicle frame when actuated to a locked position by the lever.

9. The winch cradle assembly of claim 8, wherein the two receiver brackets are bolted to the vehicle frame.

10. The winch cradle assembly of claim 8, wherein the lever of the locking mechanism is operable from a position adjacent the winch.

11. The winch cradle assembly of claim 10, wherein the lever comprises a handle and a cam- shaped base attached to linkage connecting to locking pins.
